(19) United States
(12) Patent Application Publication
(10) Pub. No.: US 2006/0262358 A1
(43) Pub. Date: Nov. 23, 2006

(54) Apparatus, method, and program for electronic filing

(76) Inventor: William Arthur Kornfeld, Palo Alto, CA (US)

Correspondence Address: PATRICK REILLY, PO BOX 7218, SANTA CRUZ, CA, 95061, US

(21) Appl. No.: 11/404,705

(22) Filed: Apr. 14, 2006

Related U.S. Application Data
(60) Provisional application No. 60/671,271, filed on Apr. 14, 2005.

(51) Int. Cl. H04N 1/00

(52) U.S. Cl. 358/403

(57) ABSTRACT

An apparatus, method, and program for routing a document to an electronic file in a server. By attaching a machine-readable code to the document and transmitting the document to a server having a program capable of reading the code, the document is routed to the appropriate file on the server.

### CROSS-REFERENCE TO RELATED APPLICATIONS

This application for patent is entitled to and claims the benefit of the filing date of Provisional Patent Application Ser. No. 60/671,271, filed Apr. 14, 2005. The aforesaid Provisional Patent Application Ser. No. 60/671,271, is integrated by reference in its entirety and for all purposes with this application for patent.

### FIELD OF THE INVENTION

The present invention relates to methods and devices for managing documents. More particularly, the present invention relates to the communication of documents by means of electronic communications systems, to include telephone systems and computer networks.

### BACKGROUND OF THE INVENTION

The electronic transmission of documents, increasingly used by commercial, educational and governmental agencies, promotes efficiency, saves time, and effort. It is commonplace, therefore, for institutions to request documents be submitted electronically via an attachment to an e-mail or by uploading to a web site. Alternatively, a document in a hardcopy version may be transmitted as a facsimile transmission (hereafter “faxed”) to the institution.

When an institution desires to mediate a transaction automatically via a software encoded program executing on a computer server, the user may be requested to transmit one or more documents electronically to the server. A variety of means may be used for electronic transmission to the server. If the document is a hardcopy, it may be submitted by scanning and uploading. Scanning a document requires specialized equipment not readily available to many users. On the other hand, access to a fax machine is more common than access to a scanning device and computer linked with the Internet or other electronic communications instrumentality. Furthermore, a fax machine is generally intended to transmit an image of a hardcopy document that is to be received as a hardcopy representation of the transmitted image. The prior art, however, does not enable automated association of routing information (such as a an e-mail address or a document index) with a fax transmission. Thus, a fax transmission received by a computer server, requires human intervention to route it to a file.

If the document to be submitted is already in electronic form and is to be transmitted to the server, the existence of hundreds of different formats used to encode a document, create additional difficulties. Thus, file formats ranging those associated with editing or authoring software, printer file formats, and various graphics interchange formats complicate electronic communication. The existence of multiple versions of file formats increases the problem for the server in rendering the document. Electronic communication is therefore hindered by a lack of a universal standard availing a server to recognize documents in a myriad of formats. One solution to this problem is to transmit the document to the server using fax technology, either by printing and loading the printed pages into a fax machine for telephonic facsimile transmission, or by using special software that encodes the document in conformance with either the CCITT Group 3 or Group 4 format and transmitting via this encoding of the document via a fax modem to the server.

Also, when fax technology is used as the mode of transmission, human intervention is required by the receiving agency to examine the document and to direct it for further processing. The intervention delays processing, is expensive and error prone. There is therefore a need to reduce or eliminate human intervention, thereby allowing communications employing fax transmissions to occur entirely or more completely electronically, which is provided by the present invention.

### OBJECTS OF THE INVENTION

It is an object of the method of the present invention to provide a method to associate a serial number with a representation of a document. It is understood that by “serial number” we mean any symbol or series of symbols that can be employed to uniquely identify the document.

It is an optional object of the present invention to provide a method to employ facsimile transmission techniques to associate a faxed image with a serial number.

### SUMMARY OF THE INVENTION

The present invention advantageously fills the aforementioned deficiency in the prior art.

Accordingly, an aspect of the invention relates to an apparatus for filing a document on a computer.

A second aspect of the invention relates to a method of using the apparatus to file a document on a computer.

A third aspect relates to a software program capable of enabling a reading of the serial number represented as a machine-readable code and thereby directing the document to a file on the computer.

Certain alternate preferred embodiments of the method of the present invention provide a method for electronic filing of documents comprising (1.) generating a serial number; (2.) communicating the serial number to a user; and (3.) communicating the serial number and a document to a computational engine; and (4.) storing the document in an electronic memory in association with the serial number, whereby the document can be retrieved from the electronic memory by a search referencing the serial number.

Certain alternate preferred embodiments of the present invention include (1.) means to encode a serial number in a machine-readable mode; (2.) means to communicate the serial number and an image of a document in a machine readable mode to a server; and (3.) means to store the image of the document in an electronic memory in association with the serial number; and (4.) means to retrieve the image by searching the electronic image for the serial number.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which: These, and further features of the invention, may be better understood with reference to the accompanying specification and drawings depicting the preferred embodiment, in which:

FIG. 1 is a schematic diagram of a first preferred embodiment of the present invention;

FIG. 2 is a schematic diagram of a second preferred embodiment of the present invention;

FIG. 3 is a schematic diagram of a third preferred embodiment of the present invention;

FIG. 4 is a schematic diagram of a fourth preferred embodiment of the present invention;

FIG. 5 is a schematic diagram of a an applicant's computer of FIGS. 2, 3 and 4;

FIG. 6 is a process chart depicting a first preferred embodiment of the method of the present invention;

FIG. 7 is a flow chart depicting a second preferred embodiment of the method of the present invention;

FIG. 8 is a flow chart depicting a third preferred embodiment of the method of the present invention; and

FIG. 9 is a flow chart depicting a fourth preferred embodiment of the method of the present invention.

### DETAILED DESCRIPTION OF THE PREFERRED EMBODIEMNTS

In describing the preferred embodiments, certain terminology will be utilized for the sake of clarity. Such terminology is intended to encompass the recited embodiment, as well as all technical equivalents, which operate in a similar manner for a similar purpose to achieve a similar result. The present invention is directed to an apparatus, method, and program for electronic filing of documents. When discussing the invention the following terms have the means indicated. Any undefined term has their art recognized meaning.

Definitions

The terms “user” and “applicant” refer to a human who is involved in a transaction where part of the transaction involves the submission of one or more specified documents.

The term “machine-readable code” refers to a code that may be printed on paper and read by an electronic device, such as a facsimile transmission system or a scanner. Examples of machine-readable codes include but are not limited to barcodes, matrix codes and fonts designed to be amenable to optical character recognition.

The term “server” refers to a computer, or a collection of computers operating in a coordinated fashion capable of sending and receiving electronic communications.

The term “program” refers to a process operating in a server or other computer such as, computational engine one for reading the machine-readable code and routing a document bearing the code to file on the server.

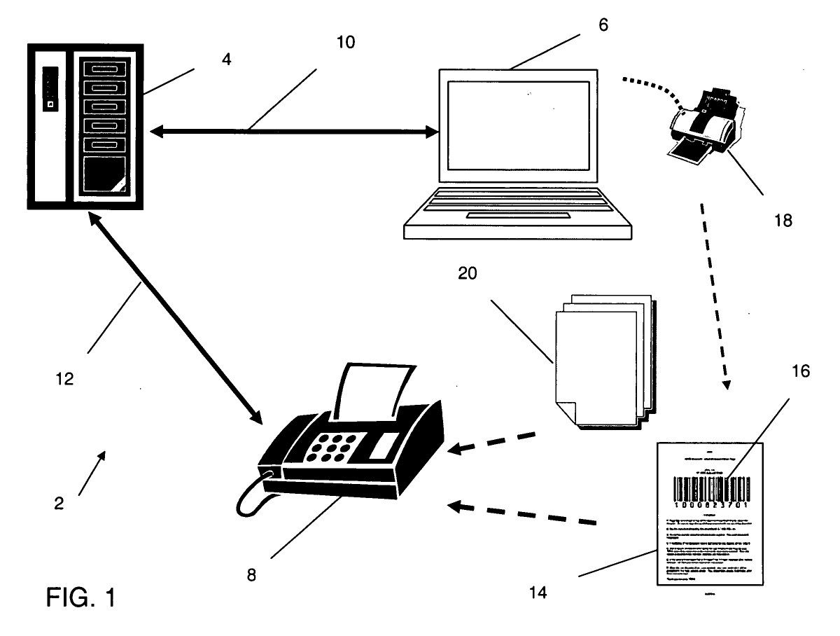

Referring now generally to the Figures and particularly to FIG. 1, FIG. 1 is a block diagram of a first preferred embodiment of the present invention 2, or first version 2. The first version 2 includes a server 4, an applicant computer 6 and a facsimile transmission system 8. The server 4 is configured to store and retrieve information by searching for serial numbers associated with specific information.

The server 4 and the applicant computer 6 may be bi-directionally communicatively coupled by means of a computer network 10 whereby data files may be transmitted between the server 4 and the applicant computer 6. The server 4 is configured to transmit data files to the applicant computer 6 via the computer network 10 and the applicant computer 6 is configure to receive data files, such as by emails bearing attachments, via the computer network 10. The computer network 10 may be or comprise the Internet in certain alternate preferred embodiments of the first version 2.

The server 4 is further configures to receive a facsimile transmission (hereafter “fax”) from the facsimile transmission system 8 (hereafter “fax machine” 8) via a telephony system 12. The server 4 and the fax machine 8 may be bi-directionally communicatively coupled by means of the telephony system 12.

In one mode of operation of the first version and in accordance with the method of the present invention, the server 4 transmits an electronic message to the applicant computer 6 via the computer network 10. The electronic message includes an electronic image of a cover sheet 14 having a bar code 16, wherein a serial number is encoded within the pattern 16. The electronic message may be an email and the electronic image may optionally be included in the body of the email and/or within an attachment of the email or by means of file download in certain still alternate preferred embodiments of the method of the first version 2. Alternatively or additionally, the server 4 may be configured to encode and transmit the cover sheet 14 to the applicant computer 6 in conformance with the CCITT Group 3 and/or Group 4 formats.

A user (hereafter “applicant”) may then print a hard copy of the cover sheet 14 by means of a printer 18 of the applicant computer 6, wherein the pattern 16 is presented on the cover sheet 14 and readable by the fax machine 8. The applicant may then transmit the cover sheet 14 and a hard copy document 20 to the server 4 by means of the telephony system 12. The server 4 then receives the instant facsimile transmission from the fax machine 8 and stores, or enables storage, of the facsimile transmission for retrieval by reference to the serial number. The fax machine 8 may be configured in certain other preferred embodiments of the first version to encode and transmit the cover sheet 14 and the document 20 in conformance with the CCITT Group 3 and/or Group 4 formats.

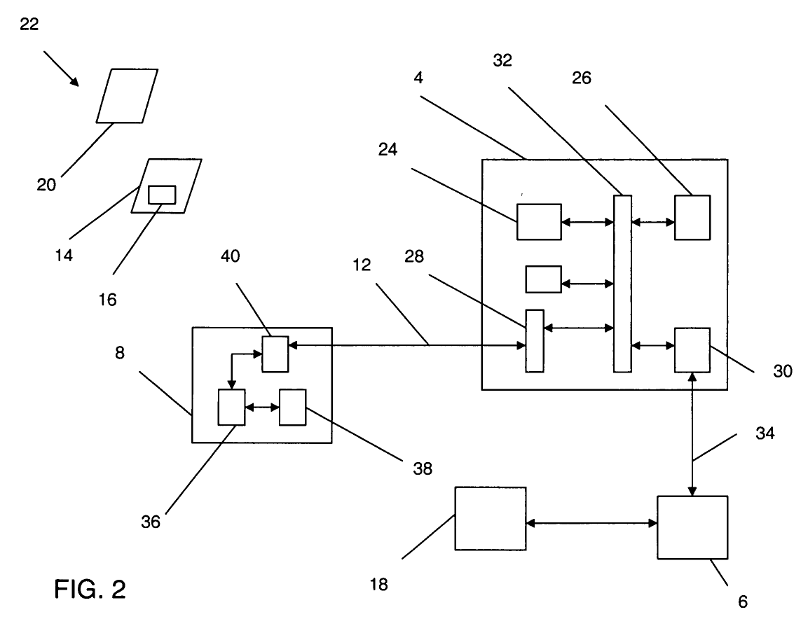

Referring now generally to the Figures and particularly to FIG. 2, FIG. 2 is a system block diagram of a second preferred embodiment of the present invention 22, or second version 22. The second version 22 includes the fax machine 8 communicatively coupled via a telephony network 12 to the server 4. The server 4 includes a central processing module 24, an electronic memory 26, a telephony interface circuit 28, an Internet interface circuit 30, and an internal communications bus 32. The central processing module 24, the electronic memory 26, the telephony interface circuit 28, and the Internet interface circuit 30 are bi-directionally communicatively coupled by and with the internal communications bus 32. The electronic memory 26 stores programs, database software and other suitable software known in the art that enables the server 4 to (1.) generate, receive and read email; (2.) to store and retrieve electronic images by reference to serial numbers; and (3.) to encode and transmit electronic documents in conformance with either the CCITT Group 3 or the Group 4 formats.

The telephony interface circuit 28 is communicatively coupled with the telephony circuit 12 and is configured to receive faxes from the fax machine 8 and provide the received faxes as electronic images for storage in the electronic memory 26. The Internet interface circuit 30 is communicatively coupled with the Internet 34 and is configured to transmit emails to from the server 4 to the applicant computer 6 via the Internet 34.

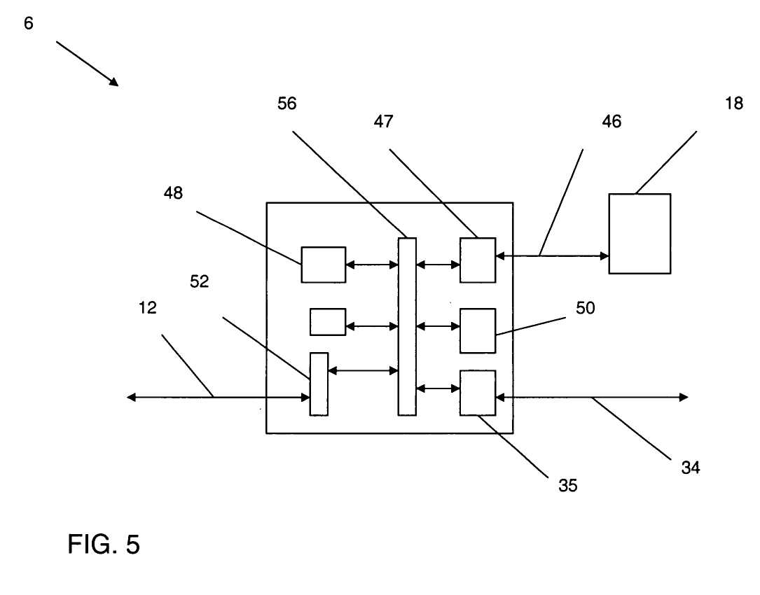

The applicant computer 6 includes an applicant interface circuit 35, a per FIG. 5, that is communicatively coupled with the Internet 34 and is configured to receive emails transmitted to receive emails transmitted from the server 4 via the Internet 34. The applicant computer 6 is further configured to read an image of the cover sheet 14 as included in an email transmitted from the server 4 via the Internet 34, and print a representation of the cover sheet on a hard copy cover sheet 14 by means of the printer 18.

The fax machine 8 includes a control module 36, a scanner 38 and a fax modem 40. The fax modem 40 is bi-directionally communicatively coupled with the telephony system 12. The scanner 38 is configured to scan and generate an output electrical signal comprising a representation of the cover sheet 14 and the document 20 in conformance with the CCITT Group 3 and/or Group 4 formats. The control module 36 is configured to transmit the output electrical signal of the scanner 38 to the server 4 via the fax modem 40 and the telephony system 12.

In one mode of operation of the second version 22 and in accordance with the method of the present invention, the server 4 transmits a data file to the applicant computer 6 via the computer network 10. The data file includes an electronic image of a cover sheet 14 including a bar code 40, wherein a serial number is encoded within the bar code 40. The data file may be transferred by email or file download or by any other mechanism.

A user (hereafter “applicant”) may then print a hard copy of the cover sheet 14 by means of a printer 18 of the applicant computer 6, wherein the bar code 16 is presented on the cover sheet 14 and readable by the scanner 38 of the fax machine 8. The fax machine 8 then encodes and transmits the cover sheet 14 and the document 20 in conformance with the CCITT Group 3 and/or Group 4 formats to the server 4 by means of the telephony system 12. The server 4 then receives the instant facsimile transmission from the fax machine 8 and stores, or enables storage, of the facsimile transmission for retrieval by reference to the serial number.

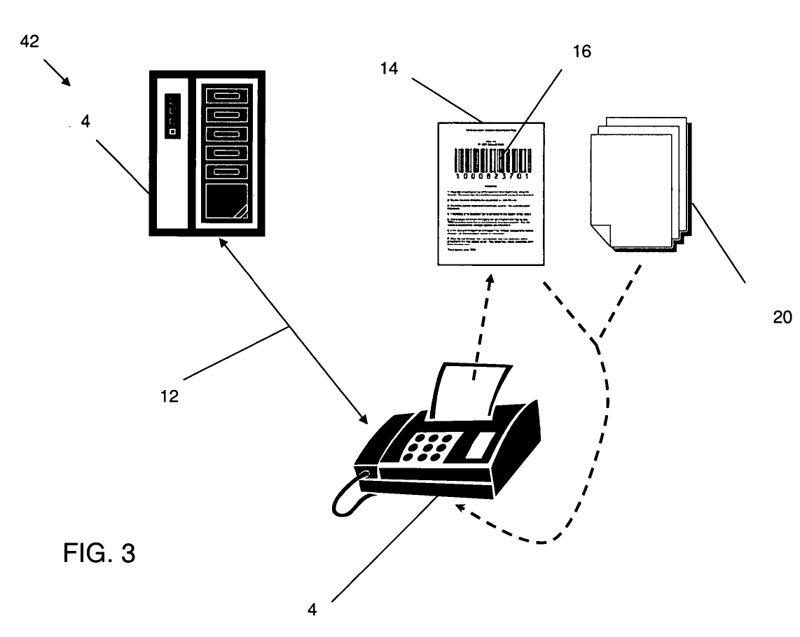

Referring now generally to the Figures and particularly to FIG. 3, FIG. 3 is a block diagram of a third preferred embodiment of the present invention 42, or third version 42. The server 4 and the fax machine 8 are bi-directionally communicatively coupled by means of the telephony network 12. The server 4 transmits an electronic image of the cover sheet 14 including the bar code 16 to the fax machine 8, wherein a fax transmission in conformance with either the CCITT Group 3 or the Group 4 formats to the server 4 via the telephony system 12. The fax machine 8 then prints the hard copy cover sheet 14. The applicant then supplies the cover sheet 14 and the hard copy document 20 to the fax machine 6 and directs the fax machine 6 to transmit an electronic image of the cover sheet 14 and the document 20 to the server 4 in a fax transmission in conformance with either the CCITT Group 3 or the Group 4 formats to the server 4 via the telephony system 12. The hard copy cover sheet 14 and the hard copy document 20 may be or comprise a sheet 43 of standard typing paper or other suitable material known in the art for visually presented a pattern readable by the fax machine 8 and for enabling facsimile transmission of a bar code 16 and other printed images of the cover sheet 14 and the document 20.

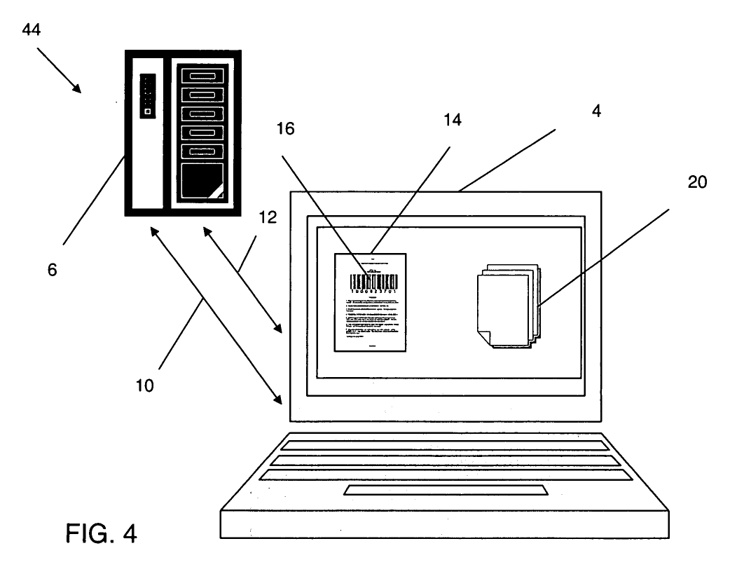

Referring now generally to the Figures and particularly to FIG. 4, FIG. 4 is a block diagram of a fourth preferred embodiment of the present invention 44, or fourth version 44. The server 4 and the applicant computer 6 are bi-directionally communicatively coupled by the computer network 10 and the telephony network 12. The server 4 may send an electronic image of the cover sheet 14 to the applicant computer 6 via the computer network 10 to the applicant computer 6. The applicant computer 6 may then send an electronic image of the cover sheet 14 and an electronic image of the document 20 via the telephony network 12 to the server 4 in a fax transmission via a fax modem in conformance with either the CCITT Group 3 or the Group 4 formats.

Referring now generally to the Figures and particularly to FIG. 5, FIG. 5 is a schematic diagram of the applicant computer 6. The applicant computer 8 includes the printer 18, a printer signal pathway 46, a printer interface circuit 47, an applicant central processing module 48, an applicant electronic memory 50, an applicant fax modem 52, an applicant Internet interface circuit 35, and an internal communications bus 56. The printer interface circuit 47, the applicant central processing module 48, the applicant electronic memory 50, the applicant fax modem 52, and the applicant Internet interface circuit 35 are bi-directionally communicatively coupled by the internal communications bus 56. The applicant memory 50 stores programs, database software and other suitable software known in the art that enables the applicant computer 6 to (1.) generate, receive and read email; (2.) to store and retrieve electronic images by reference to serial numbers; and (3.) to encode and transmit electronic documents in conformance with either the CCITT Group 3 or the Group 4 formats.

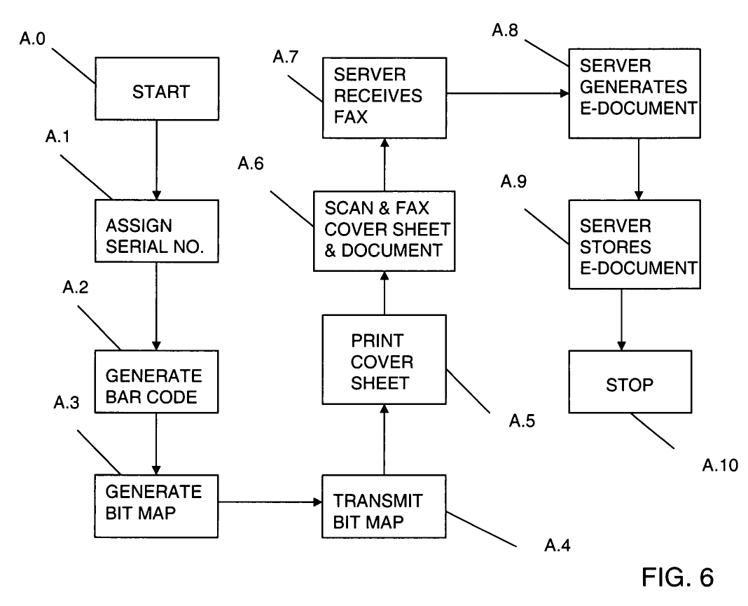

Referring now generally to the Figures, and particularly to FIG. 6, FIG. 6 presents a flow chart of a first preferred embodiment of the method of the present invention. In step A.1 a serial number is generated or assigned by the server 4. In step A.2 the serial number is encoded into a bar code pattern 16. In step A.3 the bar code pattern is integrated into a bit map of a cover sheet 14. In step A.4 the bit map is transmitted to the fax machine 8. In step A.5 the cover sheet 14 is printed by the fax machine 8, wherein the cover sheet 14 is printed on the sheet 43 and in accordance with the bit map transmitted by the server 6. In step A.6 the cover sheet 50 and the document 20 are scanned by the fax scanner 38 and transmitted via the fax modem 40 to the server 4 via the telephony network 12. In step A.7 the fax transmission of step A.6 is received by the server 4 via the server 4. In step A.8 an electronic document is generated and in step A.9 the electronic document is stored in the electronic memory 26 of the server 4 and made retrievable by reference to the serial number of step A.1.

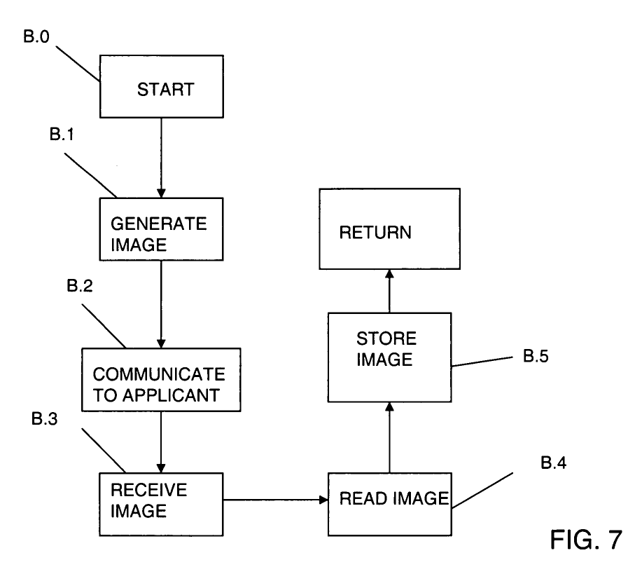

Referring now generally to the Figures and particularly to FIG. 7, FIG. 7 is a flow chart of a second preferred embodiment of the method of the present invention, wherein the server 4 generates an electronic image of a cover sheet in step B.1, wherein the cover sheet includes a representation of a bar code, the bar code having a serial number encoded therein. In step B.2 the server communicates the electronic image of the cover sheet 14 to the applicant by either a facsimile transmission of by electronic transfer using the internet. In step B.3 the server 4 receives an applicant electronic image, wherein the applicant electronic image includes an electronic image comprising an electronic image of the cover sheet 14 and an electronic image of the document 20. The applicant electronic image may be encoded in an electrical signal or message encoded and/or formatted in conformance with either the CCITT Group 3 or the Group 4 formats. In step B.4 the server 4 reads the serial number from the applicant electronic image. In step B.5 the server 4 stores the applicant electronic image, or optionally a portion of the applicant electronic image, in the electronic memory 26 of the server 4.

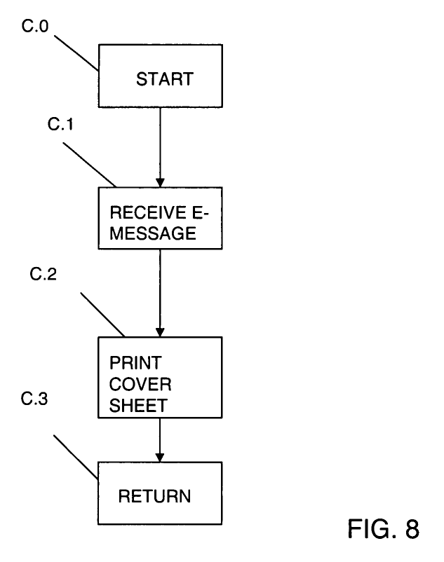

Referring now generally to the Figures and particularly to FIG. 8, FIG. 8 is a flow chart of a third preferred embodiment of the method of the present invention, wherein the applicant computer 6 receives from the server 4 an electronic image of the cover sheet 14 in step C.1. In step C.2 the applicant computer 6 prints the cover sheet on the sheet 43 by means of the printer 18. The applicant may then transmit an electronic image of the cover sheet 14 and the document 20 by means of the fax machine 8 to the server 6.

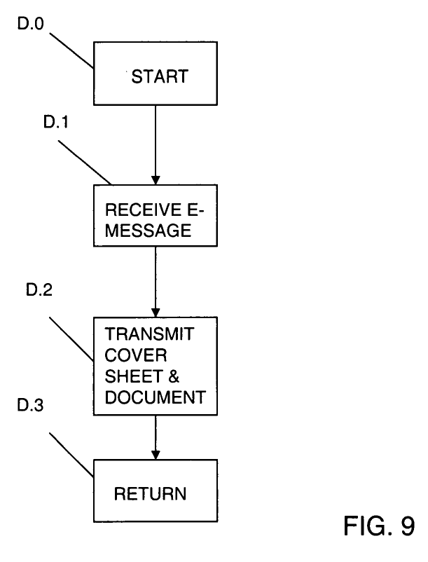

Referring now generally to the Figures and particularly to FIG. 9, FIG. 9 is a flow chart of a fourth preferred embodiment of the method of the present invention, wherein the applicant computer 6 stores an electronic image of the document 20. In step D.1 the applicant computer 6 receives from the server 4 an electronic message including an electronic image of the cover sheet 14. In step D.2 the applicant computer 6 transmits the applicant electronic image of the (1.) cover sheet 14 and (2.) the document 20, wherein the applicant electronic image

The use of a fax machine 8 and/or a fax modem 40, as a preferred means of transmitting the document to a server, circumvents a difficulty with electronic communications.

The agency to whom the documents are submitted, must receive the document 20 in a form acceptable to the server 4. The existence of hundreds of different formats that are used to encode a document creates a formidable barrier. File formats ranging those associated with editing or authoring software, printer file formats, and various graphics interchange formats complicate electronic communication. The existence of multiple versions of file formats increases the complexity. Thus, the absence of a universal standard document format diminishes the efficiency of electronic communications.

Consequently, the preferred embodiment utilizes a fax machine 8 because it may transmit a document 20 in a universally recognized format. This is because the modern fax 8 uses an international standard for telephone and telephone related devices known as CCITT Group 3. The standard utilizes a method for encoding a two-dimensional bit map into a compressed stream of bits and a method of modulation/demodulation of digital bits for transmission over a standard telephone line to a receiving device, such as a computer or another fax machine.

The interface between a fax machine 8 and a server 4, as applied in the prior art, does not allow digital information that would direct the document 20 to a file on the computer without it being examined and processed by a human. Placing a machine-readable code 16 on a cover sheet 14 allows the server to receive the document 20 and process and store the document in light of and by virtue of a program integrated into the server 4.

The use of a machine-readable code 16 that is read by a program on a server 4 has a myriad of utilities in business, service industries, and educational institutions.

The invention may be used by loan agencies for the supplying of supporting documentation for the purpose of applying for a loan.

The invention may be used by Internet pharmacies for the purpose of receiving a prescription needed to authorize a web-based purchase order placed by the user.

The invention may be used by applicants for jobs to provide specific supporting documentation such as a resume, a letter of recommendation, and a college transcript.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

What is claimed is:

1. An apparatus for electronic filing of documents comprising:
a. a first electronic device to provide a user with a machine-readable code;
b. a second electronic device communicatively coupled to said first electronic device, to receive said machine-readable code; and
c. a third electronic device to return said document and said machine-readable code to said first electronic device, wherein said first electronic device enables the storage of the transmitted document in an electronic memory and in reference to the machine-readable code.

2. The apparatus of claim 1 wherein said first electronic device is a server.

3. The apparatus of claim 1 wherein said second electronic device is a personal computer.

4. The apparatus of claim 1 wherein said third electronic device is a fax machine.

5. An apparatus for electronic filing of documents comprising:
a. a first electronic device to provide a user with a machine-readable code to be placed in conjunction with a document; and
b. a second electronic device electronically connected to said first electronic device to receive said machine-readable code and return it to said first electronic device, having a program wherein said program reads said code and routes the transmitted document.

6. The apparatus of claim 5 wherein said first electronic device is a server.

7. The apparatus of claim 5 wherein said second electronic device is a fax machine.

8. The apparatus of claim 5 wherein said second electronic device is a computer.

9. A method for communicating and storing documents, comprising:
a. communicating a serial number to a user;
b. communicating an electronic image of the serial number and a document to a computational engine; and
c. storing at least part of the electronic image in an electronic memory in association with the serial number, whereby the at least part of the electronic image can be retrieved from the electronic memory by a lookup operation referencing the serial number.

10. A method for electronic filing of documents comprising:
a. transmitting a machine-readable code by means of a first electronic device, capable of reading said machine-readable code, to a second electronic device belonging to a user.
b. placing said machine-readable code in conjunction with a document; and
c. returning said machine-readable code and said document to said first electronic device by means of said second electronic device or a third electronic device.

11. The method of claim 10 wherein said first electronic device is a server.

12. The method of claim 10 wherein said second electronic device is a personal computer further comprising a printer.

13. The method of claim 10 wherein said third electronic device is a fax machine.

14. The method of claim 10 wherein said second electronic device is a fax machine.

15. A program in an electronic device comprising:
a. a process for reading a machine-readable code; and
b. a process for routing the document according to the directions of the machine-readable code.
